(19) United States
(12) Patent Application Publication
(10) Pub. No.: US 2009/0179027 A1
(43) Pub. Date: Jul. 16, 2009

(54) Coaxial ceramic igniter and methods of fabrication

(75) Inventors: Ara Vartabedian, Hudson, MA (US); Chuanping Li, Northborough, MA (US)

Correspondence Address: EDWARDS ANGELL PALMER & DODGE LLP, P.O. BOX 55874, BOSTON, MA, 02205, US

(73) Assignee: Saint-Gobain Ceramics & Plastics, Inc., Worcester, MA (US)

(21) Appl. No.: 12/317,920

(22) Filed: Dec. 29, 2008

Related U.S. Application Data
(60) Provisional application No. 61/009,507, filed on Dec. 29, 2007.

(51) Int. Cl. H05B 3/10; B23P 17/04

(52) U.S. Cl. 219/548; 29/611

(57) ABSTRACT

New coaxial ceramic heating elements and methods for manufacture wherein a conductive core region extends into a resistive hot zone at the distal end of the heating element, thereby moving the interface between the core conductive region and the resistive hot zone away from the distal tip of the heating element. Methods comprise bringing together a pre-formed or hardened zone of material with a zone of one or more materials having flow, curing, gelling, drying or otherwise solidifying or hardening the material having flow, and sintering to thereby forming an integral coaxial heating element.

The present application claims the benefit of U.S. provisional application No. 61/009,507 filed Dec. 29, 2007, which is incorporated by reference herein in its entirety.

### BACKGROUND

1. Field

The invention provides new coaxial ceramic heating elements. The invention further provides new methods for manufacture of coaxial ceramic heating elements that include (1) bringing together a pre-formed or hardened zone of material with a zone of one or more materials having flow, (2) curing, gelling, drying or otherwise solidifying or hardening the material having flow. Preferably, the element is subsequently sintered to thereby form an integral coaxial heating element. Coaxial heating elements such as igniters and glow plugs also are provided obtainable from fabrication methods of the invention.

2. Background

Ceramic materials have enjoyed great success as igniters in e.g. gas-fired furnaces, stoves and clothes dryers. Ceramic igniter production includes constructing an electrical circuit through a ceramic component a portion of which is highly resistive and rises in temperature when electrified by a wire lead. See, for instance, U.S. Patent Publication 2006/0131295 and U.S. Pat. Nos. 6,028,292; 5,801,361; 5,405,237; and 5,191,508.

Typical igniters have been generally rectangular-shaped elements with a highly resistive “hot zone” at the igniter tip with one or more conductive “cold zones” providing to the hot zone from the opposing igniter end. One currently available igniter, the Mini-Igniter, available from Norton Igniter Products of Milford, N.H., is designed for 12 volt through 120 volt applications and has a composition comprising aluminum nitride (“AIN”), molybdenum disilicide (“MoSi₂”), and silicon carbide (“SiC”).

A variety of performance properties are required of ceramic igniter systems, including high speed or fast time-to-temperature (i.e. time to heat from room temperature to design temperature for ignition) and sufficient robustness to operate for extended periods without replacement. Many conventional igniters, however, do not consistently meet such requirements. Further, current ceramic igniters also have suffered from breakage during use, particularly in environments where impacts may be sustained such as igniters used for gas cooktops and the like.

Spark ignition systems are a proposed alternative approach to ceramic igniters. See, for instance, U.S. Pat. No. 5,911,572, for a particular spark igniter said to be useful for ignition of a gas cooking burner. One favorable performance property generally exhibited by a spark ignition is rapid ignition. That is, upon activation, a spark igniter can very rapidly ignite gas or other fuel source.

In certain applications, rapid ignition can be critical. For instance, so-called “instantaneous” water heaters are gaining increased popularity. See, generally, U.S. Pat. Nos. 6,167,845; 5,322,216; and 5,438,642. Rather than storing a fixed volume of heated water, these systems will heat water essentially immediately upon opening of a water line, e.g. a user turning a faucet to the open position. Thus, essentially immediate heating is required upon opening of the water to deliver heated water substantially simultaneously with the water being turned “on”. Such instantaneous water heating systems have generally utilized spark igniters. At least many current ceramic igniters have provided too slow time-to-temperature performance for commercial use in extremely rapid ignition applications such as required with instantaneous water heaters.

Coaxial ceramic igniters have been provided to address the need for rapid ignition. However, current coaxial igniter designs result in the generation of a majority of joule heating at or near the surface of the igniter. As a result, the igniter becomes more susceptible to external cooling and aging effects. Further, current coaxial igniter fabrication methods, such as slip casting all layers, suffer from reproducibility and consistency issues. Day-to-day and mold-to-mold dimensional variations can be present when slip casting all the layers which, if present, will impact the performance and consistency of the thus formed igniters.

### SUMMARY

New coaxial ceramic heating elements and methods for producing coaxial ceramic heating elements are now provided. Coaxial heating elements of the invention are provided with a conductive core region that extends into a resistive hot zone at the distal end of the heating element, thereby moving the interface between the core conductive region and the resistive hot zone away from the distal tip of the heating element. In other words, the resistive zone forming the hot zone is extended into the center core. As a result, the performance of the heating element is improved. For example, the present coaxial heating element design activates central heating, which can provide many benefits such as an improved resistance to external cooling and aging effects. Further, the resistive path length is increased thereby providing further benefits such as the ability to use a lower resistivity (higher PTC) material, which reduces heatup time of the igniter. The increased path length of the present coaxial heating element design can also allow for higher operational voltages. As path length becomes shorter, eventually the material resistivity needs to be so high that it is difficult to consistently make the heating elements. Thus, the extended path length design provided by the present invention further allows for more consistent heating element fabrication.

The present methods also provide further advantages such as allowing for the core and outer regions (such as core and outer conductive regions) being formed at the same level or height with respect to each other.

The present methods and heating elements further provide rapid time-to-temperature values (e.g. about 3 seconds or less, or even about 2 seconds or less). The methods of the present invention further allow for the consistent and reliable production of heating elements having particular desired properties.

In one aspect, the invention generally relates to a coaxial ceramic heating elements comprising a conductive core region mating with a hot resistive zone at the distal end of the element that, in turn mates with a second conductive zone that forms an outer region, wherein the conductive core region and outer conductive region are segregated by an insulator region.

Embodiments according to this aspect of the invention can include the following features. The heating elements can comprise multiple regions of differing electrical resistivity, e.g. a first conductive zone, a resistive hot zone, and a second conductive zone, all in electrical sequence. The heating elements can have a rounded cross-sectional shape along at least a portion of the heating element length (e.g. the length extending from where an electrical lead is affixed to the heating element to a resistive hot zone). The heating elements can have a substantially oval, circular or other rounded cross-sectional shape for at least a portion of the heating element length, e.g. at least about 10 percent, 40 percent, 60 percent, 80 percent, 90 percent or the heating element length, or the entire heating element length. The heating elements can have a substantially circular cross-sectional length that provides a rod-shaped heating element. The heating element can have a non-rounded or non-circular cross sectional length for at least a portion of the heating element length. The resistive hot zone can extend into the core region to a level that is even with level of the resistive hot zone in the outer region. The interface between the conductive zones and resistive hot zone is provided a greater distance away from the distal tip of the device than convention coaxial designs. The coaxial heating element can provide current flow through the central core and returning along the outer region of the heating element. The heating element can be axisymmetric. An interposing void (air) region can be provided between one or more regions, e.g. between the core region and insulator region. The core conductive region can be encased or otherwise nested within the outer conductive region, e.g. up to about 10, 20, 30, 40, 50, 60, 70, 80, 90 or 100 percent of the core conductive region overlaps cross-sectionally with the outer conductive region.

In another aspect, the invention generally relates to a coaxial ceramic heating element comprising a conductive core region mating with a hot resistive zone at a distal end of the heating element, and an outer conductive region separated from the conductive core region by an insulator region, wherein at least about 5% of the joule heating of the heating element is generated in the central core. In some embodiments, at least about 6%, 8%, 10%, 15%, 20%, 25%, 30%, 35%, 40%, 45%, 50%, 55%, 60%, 65%, 70%, 75%, 80%, 85%, 90%, 95%, and even 100% of the joule heating of the heating element is generated in the central core. In some embodiments, from about 10% to about 100% of the joule heating of the heating element is generated in the central core.

In another aspect, the invention generally relates to a coaxial ceramic heating element comprising a conductive core region mating with a hot resistive zone at a distal end of the heating element, and an outer conductive region separated from the conductive core region by an insulator region, wherein the conductive core region mates with the hot resistive zone at a distance “a” away from the distal tip of the heating element that is at least about 10% the total length of the heating element. In some embodiments, the core region mates with the hot zone at a distance “a” of at least about 15%, 20%, 25%, 30%, 35%, 40%, 45%, and even 50% the total length of the heating element. In some embodiments, the core region mates with the hot zone at a distance “a” ranging from about 10% to about 50% the total length of the heating element.

In another aspect, the invention generally relates to a coaxial ceramic heating element comprising a conductive core region mating with a hot resistive zone at a distal end of the heating element, and an outer conductive region separated from the conductive core region by an insulator region. The hot resistive zone extends a distance “d” within the “core region” (e.g., as depicted in FIG. 11A). In other words, the hot resistive zone extends a distance “d” from the distal-most end of the insulator region towards the proximal end of the device. This is in contrast with conventional coaxial heating elements wherein the hot resistive zone is flush or even distal to the distal-most end of the insulator region (e.g. as depicted by FIG. 11B). The hot resistive zone can be at the same level in the outer regions as in the “core region” (e.g. as shown by lines 204 and 208 in FIGS. 10 and 11A) or it can be different (e.g., as shown by the dashed lines in FIGS. 10 and 11A).

In another aspect, the invention generally relates to a coaxial ceramic heating element comprising a conductive core region mating with a hot resistive zone at a distal end of the heating element, and an outer conductive region separated from the conductive core region by an insulator region, wherein the hot resistive zone extends between the insulator region and on the outer surfaces of the insulator region, and wherein the distance along the insulator region that the hot resistive zone extends is the same between the insulator region and on the outer surfaces of the insulator region.

The heating elements can be employed at a wide variety of nominal voltages, including nominal voltages of 6, 8, 10, 12, 24, 120, 220, 230, and 240 volts.

The heating elements are useful as igniters for ignition in a variety of devices and heating systems. Specific heating systems can include gas cooking units, heating units for commercial and residential buildings, and various heating units that require very fast ignition such as instantaneous water heaters. The heating elements can also be used in igniter/glow plug applications.

In another aspect, the invention generally relates to methods for producing coaxial ceramic heating elements comprising (a) combining a pre-formed or hardened insulator region and a region of one or more materials having flow, (b) curing, gelling, drying or otherwise solidifying or hardening the region having flow, and (c) sintering to form a coaxial heating element with an inner core region and an outer region segregated by an insulator region.

Embodiments according to this aspect of the invention can include the following features. The insulator region can be in the form of a tube. The one or more materials having flow can be in the form of one or more slurries. The one or more materials having flow can be in the form of one or more powders. The process step of combining a pre-formed or hardened insulator region and a region of one or more materials having flow can comprise providing the one or more materials having flow within a mold in the desired shape of the heating element and inserting into the materials in the mold the pre-formed or hardened insulator region. The process step of combining a pre-formed or hardened insulator region and a region of one or more materials having flow can comprise inserting the pre-formed or hardened insulator region into an empty mold and at least partially filling the mold around the insulator region with the one or more materials having flow. The process step of combining a pre-formed or hardened insulator region and a region of one or more materials having flow can comprise partially inserting the pre-formed or hardened insulator region into an empty mold, at least partially filling the mold around the insulator region with the one or more materials having flow, followed by inserting the insulator region further into the mold to the desired position.

The heating element can be subject to further processing steps at any stage of the process such as dip coating and/or removal of one or more portions of the outer layer to expose one or more portions of the insulative region and/or core region.

Other aspects of the invention are disclosed infra.

### BRIEF DESCRIPTION OF THE DRAWINGS

FIG. 1 (includes FIGS. 1A through 1D) shows a preferred fabrication sequence and heating element of the invention;

FIG. 2 (includes FIGS. 2A and 2B) shows a further preferred fabrication sequence and heating element of the invention;

FIG. 3 (includes FIGS. 3A and 3B) shows a further preferred fabrication sequence and heating element of the invention;

FIG. 4 (includes FIGS. 4A and 4C) shows a further preferred fabrication sequence and heating element of the invention;

FIGS. 5, 6, 7 (includes FIGS. 7A and 7B), and 8 (includes FIGS. 8A and 8B) show exemplary heating elements.

FIG. 9 (includes FIGS. 9A-9E) shows a further preferred fabrication sequence and heating element of the invention as well as an exemplary heating element formed by the fabrication sequence;

FIGS. 10 and 11 (includes FIGS. 11A-11B) depict embodiments of the interface between the hot zone and core conductive region in relation to the length of the heating element and the insulator zones.

### DETAILED DESCRIPTION

As discussed above, new coaxial ceramic heating elements and methods for manufacture are provided. The heating elements have a coaxial structure comprising a conductive core region mating with a hot resistive zone at the distal end of the element that, in turn, mates with a second conductive zone that forms an outer region. The conductive core region and outer conductive region are segregated by an insulator region.

As referred to herein, the term “insulator” or “electrically insulating material” indicates a material having a room temperature resistivity of at least about 10¹⁰ ohms-cm. The electrically insulating material component of heating elements of the invention may be comprised solely or primarily of one or more metal nitrides and/or metal oxides, or alternatively, the insulating component may contain materials in addition to the metal oxide(s) or metal nitride(s). For instance, the insulating material component may additionally contain a nitride such as aluminum nitride (AlN), silicon nitride, SiALON, or boron nitride; a rare earth oxide (e.g. yttria); or a rare earth oxynitride.

As referred to herein, a semiconductor ceramic (or “semiconductor”) is a ceramic having a room temperature resistivity of between about 10 and 10⁸ ohm-cm. If the semiconductive component is present as more than about 45 v/o of a hot zone composition (when the conductive ceramic is in the range of about 6-10 v/o), the resultant composition becomes too conductive for high voltage applications (due to lack of insulator). Conversely, if the semiconductor material is present as less than about 5 v/o (when the conductive ceramic is in the range of about 6-10 v/o), the resultant composition becomes too resistive (due to too much insulator). Again, at higher levels of conductor, more resistive mixes of the insulator and semiconductor fractions are needed to achieve the desired voltage. Typically, the semiconductor is a carbide from the group consisting of silicon carbide (doped and undoped), and boron carbide.

As referred to herein, a “conductive material” is one which has a room temperature resistivity of less than about 10⁻² ohm-cm. If the conductive component is present in an amount of more than 35 v/o of the hot zone composition, the resultant ceramic can become too conductive. Typically, the conductor is selected from the group consisting of molybdenum disilicide, tungsten disilicide, and nitrides such as titanium nitride, and carbides such as titanium carbide. Molybdenum disilicide is generally preferred.

For any of the ceramic compositions (e.g. insulator, conductive material, semiconductor material, resistive material), the ceramic compositions may comprise one or more different ceramic materials (e.g. SiC, metal oxides such as Al₂O₃, nitrides such as AlN, Mo₂Si₂ and other Mo-containing materials, SiAlON, Ba-containing material, and the like). Alternatively, distinct ceramic compositions (i.e. distinct compositions that serve as insulator, conductor and resistive (ignition) zones in a single heating element) may comprise the same blend of ceramic materials (e.g. a binary, ternary or higher order blend of distinct ceramic materials), but where the relative amounts of those blend members differ, e.g. where one or more blend members differ by at least 5, 10, 20, 25 or 30 volume percent between the respective distinct ceramic compositions.

A variety of compositions may be employed to form a heating element of the invention. Generally preferred hot zone compositions comprise at least three components of 1) conductive material; 2) semiconductive material; and 3) insulating material. Conductive (cold) and insulative (heat sink) regions may be comprised of the same components, but with the components present in differing proportions, as mentioned above. Typical conductive materials include e.g. molybdenum disilicide, tungsten disilicide, nitrides such as titanium nitride, and carbides such as titanium carbide. Typical semiconductors include carbides such as silicon carbide (doped and undoped) and boron carbide. Typical insulating materials include metal oxides such as alumina or a nitride such as AlN and/or Si₃N₄.

In general, preferred hot (resistive) zone compositions include (a) between about 50 and about 80 v/o of an electrically insulating material having a resistivity of at least about 10¹⁰ ohm-cm; (b) between about 5 and about 45 v/o of a semiconductive material having a resistivity of between about 10 and about 10⁸ ohm-cm; and (c) between about 5 and about 35 v/o of a metallic conductor having a resistivity of less than about 10⁻² ohm-cm. Preferably, the hot zone comprises 50-70 v/o electrically insulating ceramic, 10-45 v/o of the semiconductive ceramic, and 6-16 v/o of the conductive material. A specifically preferred hot zone composition for use in heating elements of the invention contains 10 v/o MoSi₂, 20 v/o SiC and balance AlN or Al₂O₃.

As used herein, “pre-formed”, e.g. when referring to a zone or material(s), indicates a zone or material(s) that do not have flow and do not change shape when combined with a zone of material having flow.

As used herein, a material or zone having “flow” indicates a zone or material(s) that, when combined with the pre-formed zone or material(s), is displaced to accommodate the pre-formed zone or material(s). The material includes, for example, slurries and powders.

As used herein, “time-to-temperature” or similar terms refers to the time for an igniter hot zone to rise from room temperature (ca. 25° C.) to a fuel (e.g. gas) ignition temperature of about 1000° C. A time-to-temperature value for a particular igniter is suitably determined using a two-color infrared pyrometer.

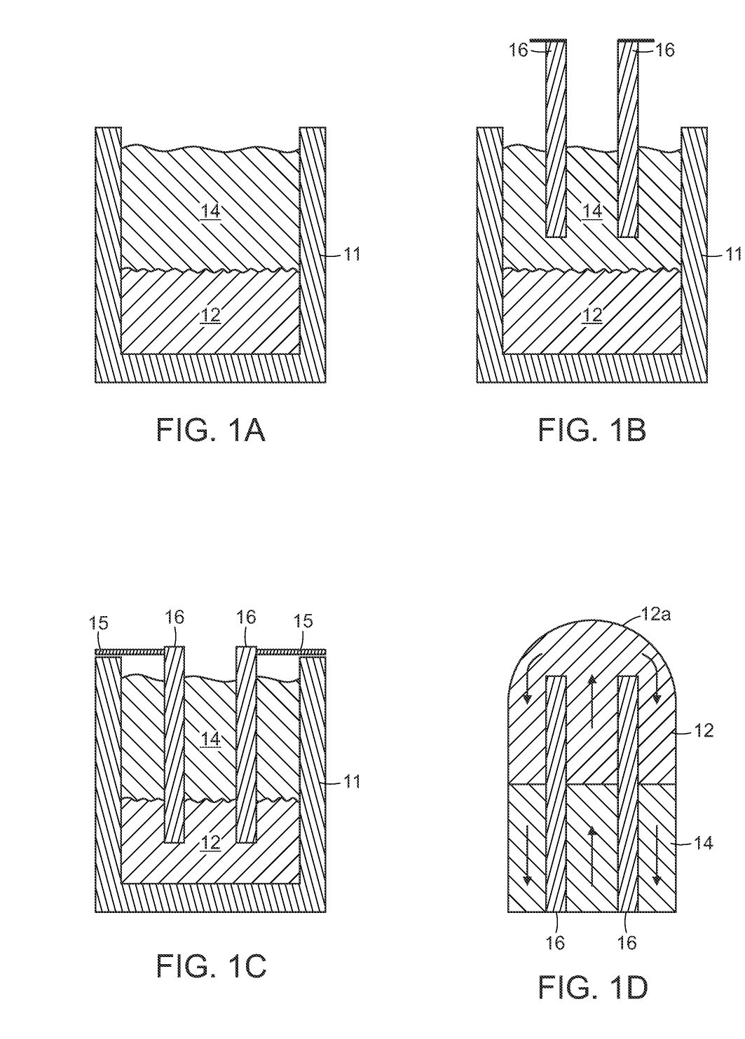

Referring now to the drawings, FIGS. 1A-D show one embodiment of a method for forming a coaxial heating element 10. A first material having flow 12 is provided in a mold 11 having any desired heating element shape. For example, as shown in the figures, a rod-like heating element having a rounded cross-section, particularly circular, is provided using mold 11. Of course, any mold shape can be similarly used. A second material having flow 14 is also provided in mold 11.

The first and second materials 12, 14 should not significantly intermix upon addition to the mold 11 e.g. as shown in FIG. 1A.

Such segregation of the materials 12, 14 can be accomplished by any of several ways. For example, the materials 12, 14 can be introduced into the mold 11 in sufficiently high viscosities to avoid substantial intermixing. In this approach, materials 12, 14 could be introduced as powders, or as viscous compositions (e.g. composition that comprise polymeric binder(s)) that do not substantially intermix.

Materials 12, 14 also can be introduced into the mold 11 in lower viscosity compositions that avoid intermixing, e.g. in compositions having carrier solvents of differing polarities such as one material being introduced as an aqueous composition and a second material being introduced with an organic solvent carrier.

In a further approach, first and second materials 12, 14 having different densities can be utilized with the first material 12 being denser than the second material 14 such that the first material settles at the bottom of the mold and the second material settles at the top of the mold in two phases.

A typical composition for material 12 or 14 to be added to a mold include the respective ceramic powders (e.g. Al₂O₃, SiC, MoSi₂, AlN, Si₃N₄) combined with water and/or organic solvent(s), binder(s), dispersant and pH control to make the appropriate slurry. One binder composition may comprise about 6-8 wt % vegetable shortening, 2-4 wt % polystyrene and 2-4 wt % polyethylene

Of course, some amount of mixing between the phases can be present, for example, along the region of interface between the phases which can provide for enhanced strength and binding between the phases upon solidifying or hardening of the phases.

The materials 12, 14 can be introduced to the mold simultaneously or in any order and, upon settling will form two phases as described. For ease and for faster production times, the first material 12 is added first and the second material 14 is added second. The second material can be added in a gradual manner so as to prevent excessive mixing between the first and second materials 12, 14 which may require additional time for the materials 12, 14 to settle into their phases.

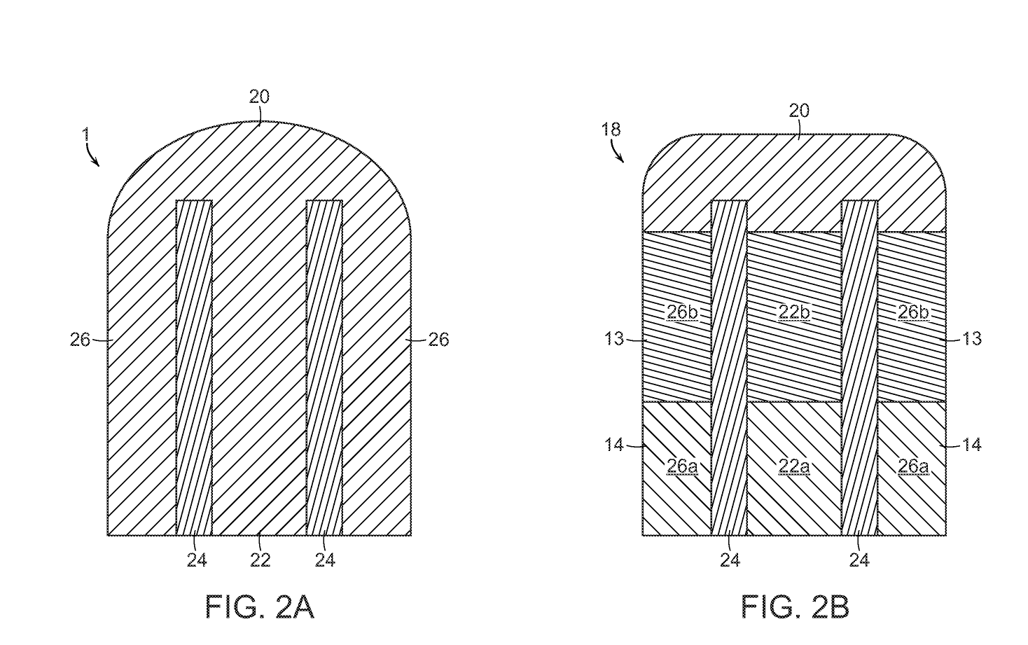

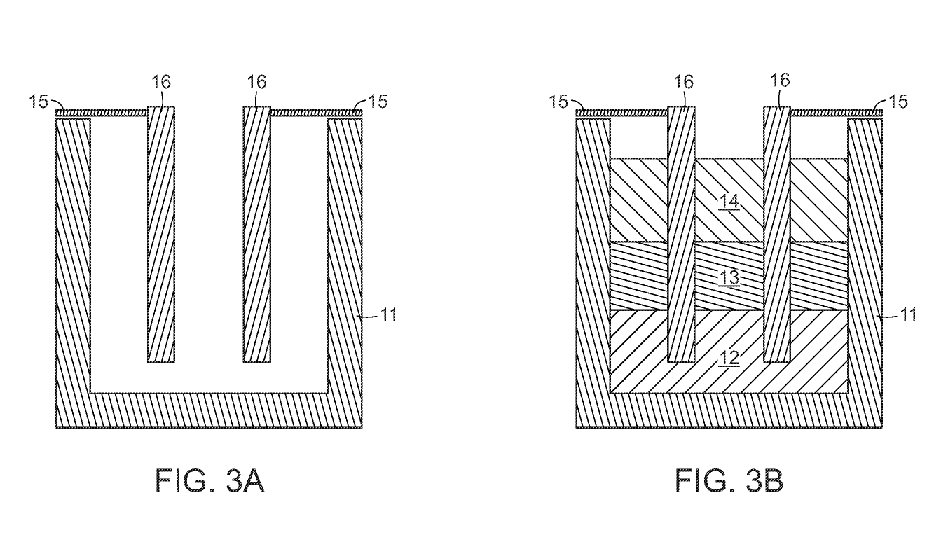

In some embodiments, the first and second materials 12, 14 differ in resistivity. For example, in an exemplary embodiment, the first material 12 is a resistive material that forms the distal end 12a of the heating element, while the second material 14 is a conductive material, thereby resulting in a heating element having a “hot zone” at its distal end 12a (e.g. as shown in FIG. 1D). One or more further materials having resistivities different than those of the first and second materials 12, 14 can further be provided as desired to form a heating element having further zones differing resistivity (e.g. as shown in FIGS. 2B and 3B with a third material 13 being positioned between the first material 12 and the second material 14 so as to form a “booster zone”). As shown in FIG. 1B, a pre-formed or hardened insulator region 16 is then inserted into the first and second materials 12, 14 within the mold. Because the materials 12, 14 have flow, they are displaced by the insulator region 16 as it is pushed into its desired position within the mold. The insulator region 16 can, in some embodiments, be provided with a pointed or sharpened distal end to facilitate insertion. In some embodiments, the insulator region 16 is provided with one or more protrusions 15 at the proximal end to properly locate the insulator region 16 within the mold (e.g. as shown in FIGS. 1C and 3A-3B). For example, when in the form of a tube having a substantially circular cross-sectional shape, the proximal end of the insulator region 16 can have, for example, a lip about its circumference configured such that the lip rests on the top surface of the mold to thereby position and hold the insulator region 16 in its proper position during fabrication. Any other suitable protrusion(s) to similarly facilitate positioning of the insulator region 16 can be provided (e.g. opposing tabs extending from the proximal end of the insulator region 16). The protrusions are typically formed of insulator material, and preferably are formed of the same material as insulator region 16. However, different materials can be used for the protrusions 15, if desired. These protrusions can optionally be removed after fabrication of the heating element (e.g. after hardening/solidifying materials 12, 14 or after sintering) and, for example, may be provided for easy detachment or can be machined off or similarly removed if desired. Once the insulator region 16 is properly positioned, and the materials 12, 14 allowed to settle into their phases as desired/if required, the materials 12, 14 are exposed to conditions and/or processed as required to harden or solidify the materials 12, 14 (e.g. by curing, gelling, drying, and/or other suitable means). The thus formed heating element is then removed from the mold and subject to suitable further processing steps as desired. In particular, the heating element is sintered at high temperatures (e.g. greater than 1600° C., 1700° C. or 1800° C.) to form a dense heating element.

The thus formed heating element 1 is shown in FIGS. 2A and 2B and is provided with a conductive core region 22 mating with a hot resistive zone 20 at the distal end of the element that, in turn, mates with a second conductive outer region 26. The conductive core region 22 and outer conductive region 26 are segregated by an insulator region 24. In accordance with this embodiment, hot zone 20 is formed of the first material 10. The core region 22 and outer region 26 are formed of the same material, which is the second material 14 shown in FIGS. 1A-1D. As shown in the embodiment of FIG. 2B, when a third material 13 is provided in the mold, the core region 22 and outer region 26 are also formed of the same material, which is a combination of the second material 14 and third material 13.

The heating element can, in some embodiments, be subjected to one or more additional processing steps in accordance with conventional techniques to provide further desired properties such as, for example, dip coating, removal of one or more portions of the outer layer.

FIGS. 3A and 3B show another embodiment of a method for forming a coaxial heating element. As shown in FIG. 3A, a pre-formed or hardened insulator region 16 is inserted into the mold 11 in its desired end position (e.g. by the use of protrusion(s) on the proximal end of the insulator region 16 which can facilitate proper positioning). A first and second material 12, 14 (and, in some embodiments, one or more further materials such as a third material 13) having flow are then provided in the mold simultaneously or sequentially in any order and, due to their flow properties, fill up the space of the mold 11 about the insulator region 16. The first and second materials 12, 14 do not substantially intermix as discussed herein. If desired, the insulator region 16 can be further manipulated and positioned within the materials 12, 14. The materials 12, 14 are then exposed to conditions and/or processed as required to harden or solidify the materials 12, 14 (e.g. by curing, gelling, drying, and/or other suitable means). The thus formed heating element is then removed from the mold and subject to suitable further processing steps as desired and set forth herein. The thus formed heating element 18 would be the same as that provided in accordance with the methods of FIGS. 1A-1D, and is shown in FIGS. 2A-2B.

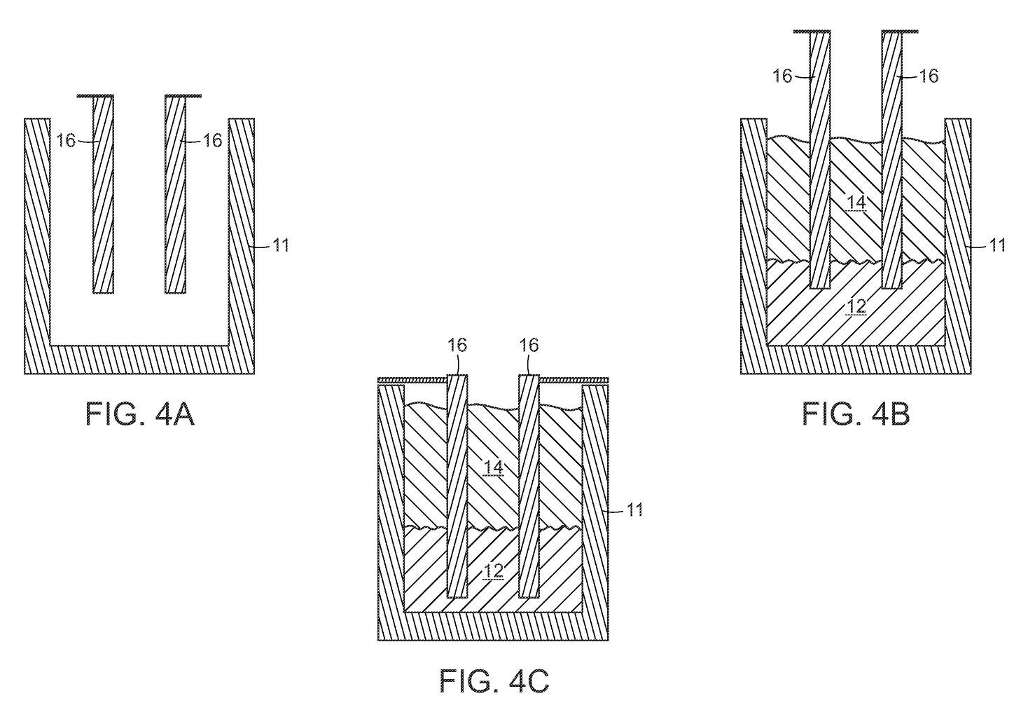

FIGS. 4A-4C show another embodiment of a method for forming a coaxial heating element. This method is a combination of methods shown in FIGS. 1A-1D and that shown in FIGS. 3A-3B. As shown in FIG. 4A, a pre-formed or hardened insulator region 16 is partially inserted into the mold 11. A first and second material 12, 14 (and, in some embodiments, one or more further materials such as a third material 13) having flow are then provided in the mold simultaneously or sequentially in any order and, due to their flow properties, fill up the space of the mold 11 about the insulator region 16. The insulator region 16 is then inserted or pushed further into the materials 12, 14 in the mold to its desired end position, thereby displacing the materials 12, 14 as described herein. Once the insulator region 16 is properly positioned, the materials 12, 14 are exposed to conditions and/or processed as required to harden or solidify the materials 12, 14 (e.g. by curing, gelling, drying, and/or other suitable means). The thus formed heating element is then removed from the mold 11 and subject to suitable further processing steps as desired. The thus formed heating element 18 would be the same as that provided in accordance with the methods of FIGS. 1A-1D and 3A-3B, and is shown in FIGS. 2A-2B.

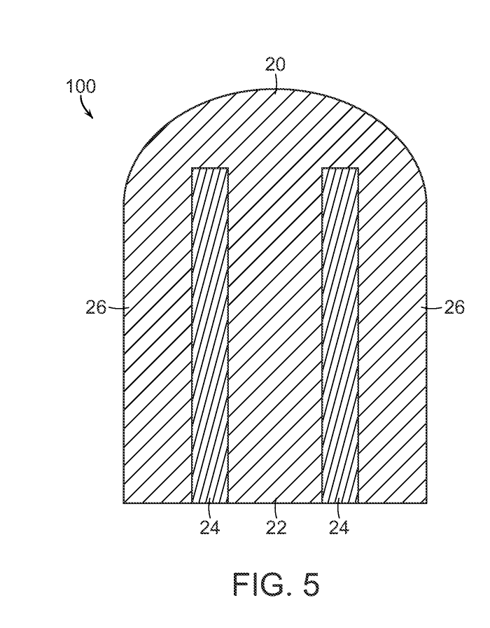

As generally shown in FIG. 5, preferred heating elements 100 of the invention may comprise generally a conductive core region 22 mating with a hot resistive zone 20 at the distal end of the element that, in turn, mates with a second conductive outer region 26. The conductive core region 22 and outer conductive region 26 are segregated by an insulator region 24.

In accordance with some embodiments of the present invention, before or after the insulator region 16 is provided in the mold, the mold is filled partially with a resistive material 12 while the remainder of the mold is filled to the desired level with a conductive material 14. The resistive and conductive materials can, in certain embodiments, be in the ceramic slurry form and gel or slip casting techniques could be employed. The resistive and conductive materials can, in certain other embodiments, be in the form of a ceramic powder. The pre-formed or hardened/solid insulator region 16 can be formed into its desired shape prior to insertion into the mold by any suitable methods for forming insulators such as, for example, gel casting, slip casting, extrusion, injection molding, pressing, CIP, etc. Gelling and/or drying would be examples of suitable processing steps to harden slurries, while pressing or CIP processing would be suitable processing steps for powder materials.

In some embodiments, a booster zone is provided, for example, as shown in FIG. 2B wherein the core region 22 comprises a first conductive zone 22a of relatively low resistance (formed of conductive material 14), and a second conductive zone 22b of intermediate resistance (formed of conductive material 13), and wherein the outer region 26 also comprises a first conductive zone 26a of relatively low resistance (formed of conductive material 12) and a second conductive zone 26b of intermediate resistance (formed of material 13). As such, the resulting heating element is provided with at least three zones of differing electrical resistance in sequence along its electrical pathway comprising a first conductive zone of relatively low resistance, a booster zone (also sometimes referred to as an enhancement zone) of intermediate resistance, and a hot zone (also sometimes referred to as an ignition zone) of high resistance. The booster zone is generally provided with a positive temperature coefficient of resistance (PTCR) and can provide more effective current flow to the hot zone. See U.S. Patent Publication 2002/0150851 to Willkens.

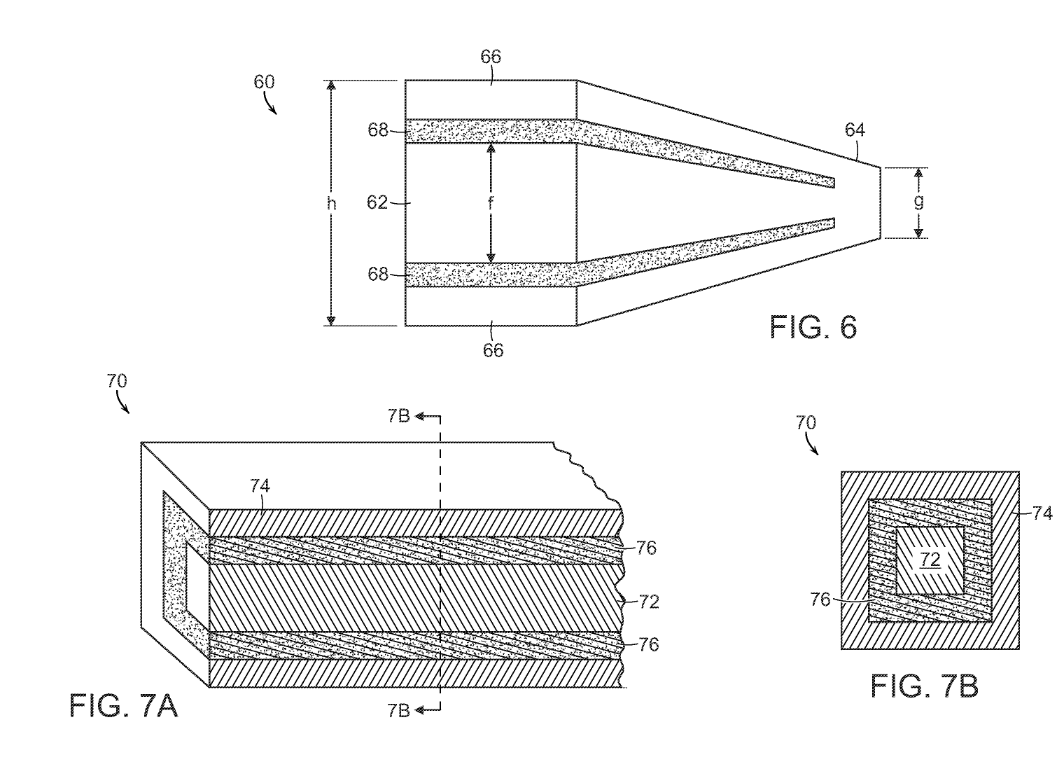

In some embodiments, the heating element width or cross-sectional area is decreased or tapered at a distal area. For example, the heating element can be formed of conductive areas along a portion of its length and can, further be provided with a tapered distal portion, which provides increased resistance. For example, a first conductive area 62 of an igniter (e.g. at the proximal end of the core) may have a maximum cross-sectional area or width (width f in FIG. 6) that is at least 2, 3, 4, 5, 6, 7, 8, 9 or 10 times greater than a hot zone 64 minimum cross-sectional area or width (width g in FIG. 6). In some embodiments, the conductive area 62 and hot zone 64 are formed of the same material with the increased resistance in the hot zone 64 provided solely by tapering. In some embodiments, the hot zone 64 is formed of a material having a greater resistance than that of the conductive area 62 with the tapering of the hot zone 64 further enhancing the increased resistance in the hot zone 64. By such a decreasing width or cross-sectional area of a hot zone area, the differences in compositions used to form the conductive and hot zones can be minimized, which can provide advantages of enhanced mating of the distinct zones, including good matching of coefficients of thermal expansion of the compositions of the distinct zones, which can avoid cracking or other potential degradation of the igniter. More particularly, such a decreasing width or cross-sectional area of a hot zone area can enable use of a ceramic composition in a hot zone area that is relatively conductive and at least approximates the ceramic material employed for conductive zones. In these systems, rather than the ceramic material itself (or in addition to the ceramic material), the decreased hot zone width provides resistive heating.

As discussed herein, an insulator zone 68 is interposed between the core 62 and the outer region 66 as shown. It is noted that while FIG. 6 shows a heating element having a cross-sectional width or dimension that gradually tapers along its length, the heating element can also be provided with different tapering configurations. For example, the heating element can be substantially constant in cross-sectional width or dimension along a proximal conductive portion and can taper only at a distal hot zone area.

While a rounded cross-sectional shape is used for many applications, heating elements of the invention also may have a non-rounded or non-circular cross-sectional shape for at least a portion of the heating element length, e.g. where up to or at least about 10, 20, 30, 40, 50, 60, 70 80 or 90 percent of the heating element length has a cross-sectional shape that is non-rounded or non-circular, or where the entire heating element length has a cross-sectional shape that is non-rounded or non-circular.

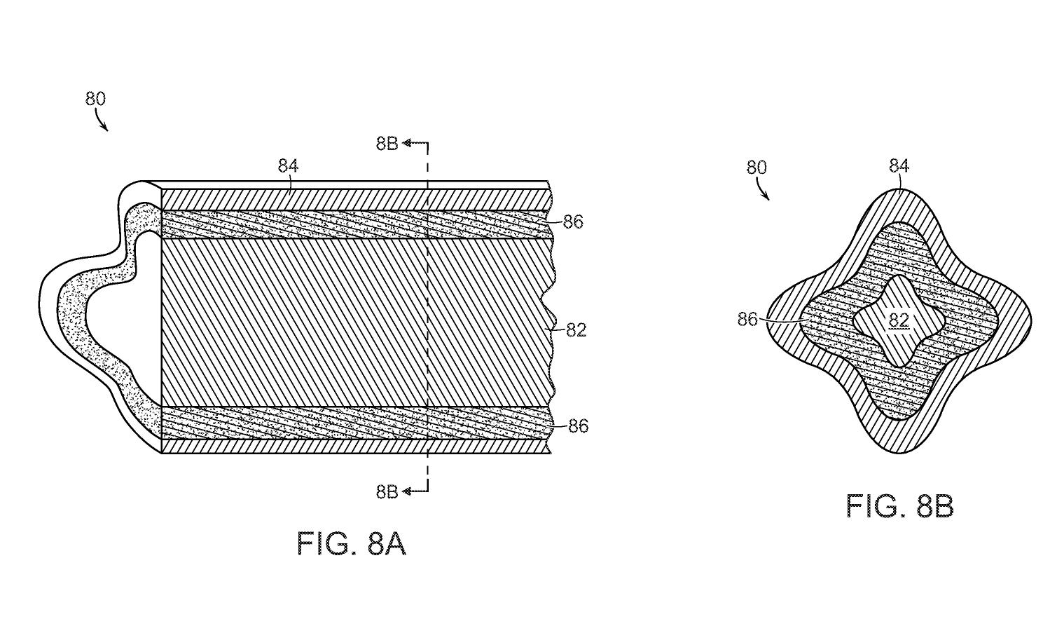

For example, a heating element may be provided in a substantially square profile as exemplified by heating element 70 depicted in FIGS. 7A and 7B. Heating element 70 comprises a rectangular-like or a stilt-like core conductive zone 72 with angular cross-sectional shape (more particularly, substantially square cross-sectional shape as clearly depicted in FIG. 7B), a similarly angular outer conductive zone 74, and an insulator region 76 interposed therebetween. A hot zone can further be provided such as that set forth herein.

A heating element with an irregular rounded shaped profile also may be provided as exemplified by the heating element 80 as shown in FIGS. 8A and 8B. The heating element 80 comprises a core conductive zone 82 and outer conductive zone 84, each having irregular rounded cross-sectional shapes, and an irregular shaped insulator region 86 interposed therebetween. A hot zone can further be provided such as that set forth herein.

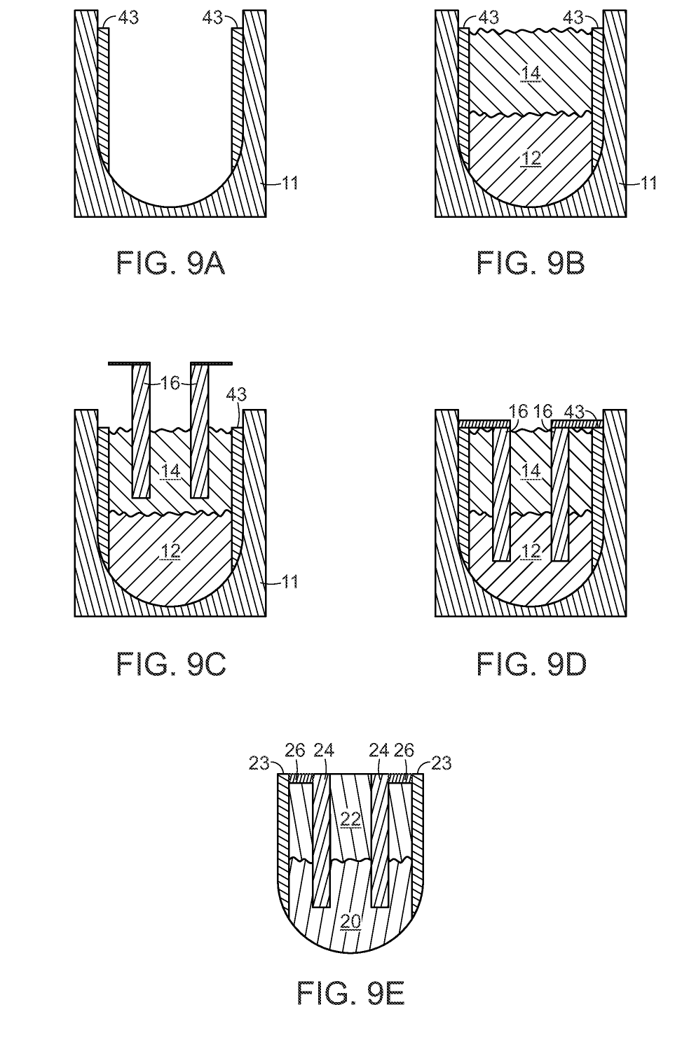

In some embodiments, to may be desirable to add one or more further layers to the coaxial heating element. For example, as shown in FIGS. 9A-9E, a further outer layer 23 can be provided. In certain embodiments, this outer layer 23 is an insulator layer. The general methods described above could be used in forming the heating element with an additional step of inserting into the mold 11a further pre-formed insulator region 43 so as to line the mold along at least a portion of its surface. The insulator region 43 is generally inserted as a first step, for example, as shown in FIG. 9A, followed by the further process steps in any order as set forth above (e.g. introduction of the first and second materials 12/14 and insulator region 46 in any order, hardening or solidifying the materials 12, 14, and sintering) to provide a heating element having one or more further layers. For example, as shown in FIG. 9E, the heating element can be provided with a conductive core region 22 mating with a hot resistive zone 20 at the distal end of the element that, in turn, mates with a second conductive outer region 26. The conductive core region 22 and outer conductive region 26 are segregated by an insulator region 24 and the outer surface of the device is coated, along at least a portion of its length, with an outer insulator region 23.

In another embodiment, the heating element can be provided with one or more further “interior” layers. For example, the heating element can be provided in accordance with any of the methods discussed herein with one or more additional pre-formed insulator regions (e.g. further coaxial insulator tubes) being inserted within and/or about insulator region 16. The additional insulator region(s) can be inserted at any stage prior to hardening or solidifying the materials 12, 14. Any shape, number, and configuration of insulator regions can be provided (e.g. for example, while elongate insulator regions extending longitudinally along the heating element are generally shown, the insulator regions are not so limited and, for example, can run in different directions along the heating element body. Further layers can be provided, if desired, such as an outer insulator coating as discussed in connection with FIGS. 9A-9E.

Dimensions of heating elements of the invention may vary widely and may be selected based on its intended use. For instance, the length of a heating element suitably may be from about 0.5 to about 5 cm, in some embodiments from about 1 about 3 cm. The heating element cross-sectional width may suitably be from about 0.2 to about 3 cm. Similarly, the lengths of the conductive, insulator, and hot zone regions also may suitably vary. An exemplary length the core conductive region may be from about 0.2 cm to about 2 cm, to about 3 cm, to about 4 cm, to about 5 cm, or more. Typical lengths of the core conductive zone will be from about 0.5 to about 5 cm. The height of a hot zone may be from about 0.1 cm to about 2 cm, to about 3 cm, to about 4 cm, or to about 5 cm, with a total hot zone electrical path length of about 0.2 to about 2 cm or more. A typical length of the hot zone electrical path ranges from about 1.5 cm to about 2 cm.

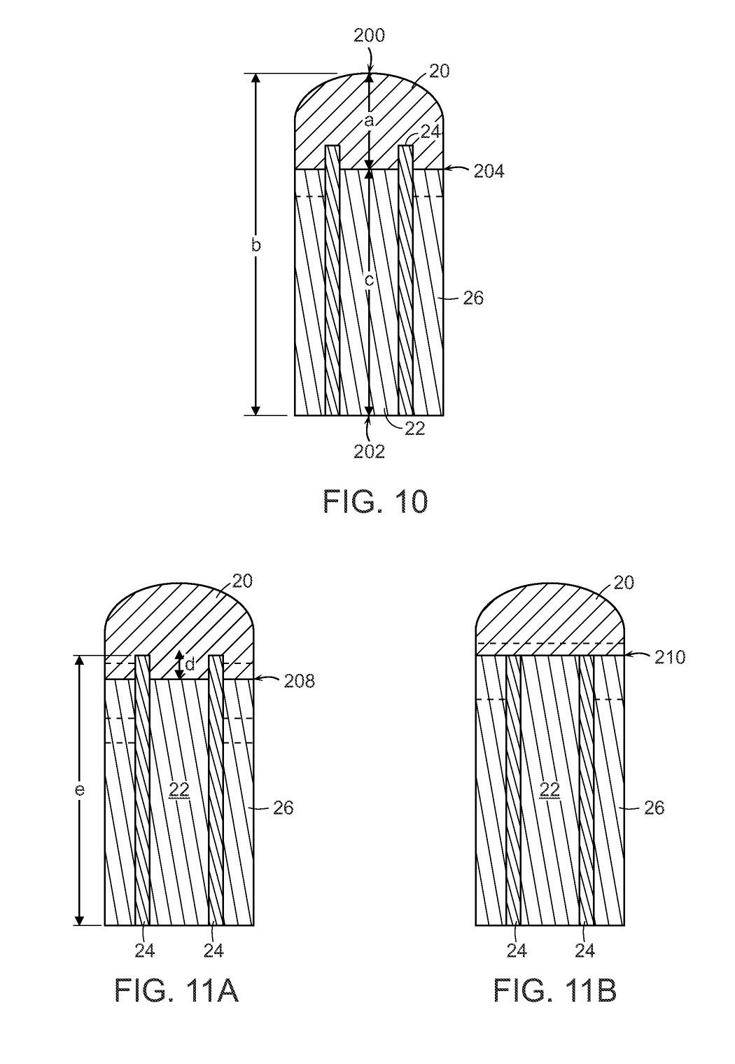

Coaxial heating elements formed in accordance with the present invention provide a conductive core region 22 that mates or meets with a hot resistive zone 20 at a distal end of the heating element, and an outer conductive region 26 separated from the conductive core region 22 by an insulator region 24, wherein the conductive core region 22 mates with the hot resistive zone 20 (e.g. as shown by interface lines 204 and 208 in FIGS. 10 and 11A). This interface is provided at a greater distance “a” away from the heating element distal tip 200 than conventional coaxial heating elements. In particular, coaxial heating elements provide a hot resistive zone 20 that is flush or distal to the insulator region 24 distal-most end in the core region (between or within the insulator regions 26), for example, as shown by line 210 and dashed lines in FIG. 11B. For example, the present heating elements and methods can provide a distance “a” away from the distal tip 200 that is at least about 10% the total length “b” of the heating element. In some embodiments, the core region 22 mates with the hot zone 20 at interface 204 at a distance “a” of at least about 15%, 20%, 25%, 30%, 35%, 40%, 45%, and even 50% the total length “b” of the heating element. In some embodiments, the core region 22 mates with the hot zone 20 at a distance “a” ranging from about 10% to about 50% the total length “b” of the heating element. The interface between the outer conductive regions 26 and the hot resistive zone 20 can be even with that of the interface within the core region 22 (e.g. as shown by lines 204 and 208 in FIGS. 10 and 11A) or the interface can be at a “higher” or “lower” level than that within the core region 22 (e.g. as shown by the dashed lines in FIGS. 10 and 11A). While the level of the interface between the resistive hot zone 20 and conductive zone within the outer region 26 is generally uniform, it can vary if desired.

In some embodiments, as depicted in FIG. 11A, the hot resistive zone 20 extends a distance “d” within the “core region” (i.e. between or within the insulator region 24). In other words, the hot resistive zone extends a distance “d” from the distal-most end of the insulator region 24 towards the proximal end of the device. This is in contrast with conventional coaxial heating elements wherein the hot resistive zone is flush or even distal to the distal-most end of the insulator region (e.g. as depicted by FIG. 11B). In some embodiments, distance “d” is at least 1% the total length of the insulator region (as shown by “e” in FIG. 11A). In some embodiments, the distance “d” is at least 2% distance “e”, at least 4%, 6%, 8%, 10%, 15%, 20%, 25%, 30%, 35%, 40%, 45%, and even 50%. In some embodiments, the distance “d” is from about 1% to about 50% distance “e”.

In exemplary embodiments, the hot or resistive zone of a heating element of the invention will heat to a maximum temperature of less than about 1450° C. at nominal voltage; and a maximum temperature of less than about 1550° C. at high-end line voltages that are about 110 percent of nominal voltage; and a maximum temperature of less than about 1350° C. at low-end line voltages that are about 85 percent of nominal voltage.

While the present heating elements and methods have been described wherein an inner conductive core region 22 is separated from an outer conductive region 26 by an insulator region 24, it is to be understood that the core region 22 and/or outer region 26 could be formed of one or more insulator materials while the region 24 interposed between the core region and outer region could be formed of one or more conductive materials. Further, while the embodiments described herein include a hot zone 20 provided by a composition of increased resistivity, such a hot zone formed by a composition of distinct resistivity could be eliminated in some embodiments. In some embodiments, a hot zone 20 by a composition of distinct resistivity is eliminated and the heating element is provided with a tapered distal end to provide increased resistance at the distal end.

The following non-limiting example is illustrative of the invention. All documents mentioned herein are incorporated herein by reference in their entirety.

### EXAMPLE 1

### Heating Element Fabrication

Powders of a resistive composition (20 vol % MoSi₂, 5 vol % SiC, 74 vol % Al₂O₃ and 1 vol % Gd₂O₃), a conductive composition (28 vol % MoSi₂, 7 vol % SiC, 64 vol % Al₂O₃ and 1 vol % Gd₂O₃) are mixed with 10-16 wt % organic binder (about 6-8 wt % vegetable shortening, 2-4 wt % polystyrene and 2-4 wt % polyethylene) to form two pastes with about 62-64 vol % solids loading.

The resistive composition paste is loaded to a U-shaped mold as generally depicted in FIGS. 1A-1D followed by loading of the conductive paste composition on top of the resistive composition to provide segregated ceramic composition layers as generally shown in FIG. 1A.

Two pre-formed insulator tubes are then inserted into the mold whereby the insulator tubes extend through the conductive composition layer and into the resistive composition layer. The insulator tubes are formed from a composition of an insulating composition 10 vol % MoSi₂, 89 vol % Al₂O₃ and 1 vol % Gd₂O₃.

The thus filled mold is then thermally treated in excess of 1000° C. for 1 hour to harden the three zone heating element. The heating element is then removed from the mold and densified to 95-97% of theoretical at 1750° C. in Argon at 1 atm pressure.

### EXAMPLE 2

### Heating Element Fabrication

A resistive slurry and a conductive slurry, both with approximately 50 vol % solids, are formed using the following components: water, Al₂O₃, MoSi₂, SiC, Kelcogel (gelling agent), Darvan 811 (dispersant), WB4101 and M040 (binders), and CaCl₂. In particular, a solids mixture of 50-95 wt % Al₂O₃, 10-45 wt % MoSi₂, and 0-5 wt % SiC is prepared. A liquid mixture of 90-95 wt % water, 1-4 wt % Kelcogel, 1-4 wt % Darvan 811, 0.5-2.0 wt % binders (WB4104 and M040), and 0.25-1.0 wt % CaCl₂ is also prepared. The solids and liquid mixtures are then combined to provide a slurry containing 40-60 vol % solids.

The resistive slurry is loaded to a U-shaped mold as generally depicted in FIGS. 1A-1D followed by loading of the conductive slurry on top of the resistive composition to provide segregated ceramic composition layers as generally shown in FIG. 1A.

A pre-formed insulator tube is then inserted into the mold whereby the insulator tubes extend through the conductive composition layer and into the resistive composition layer.

The thus filled mold is then dried and removed from the mold. Thereafter, the element is gelled, densified by sintering, and pressed (hot isostatic pressing). Further machining and brazing steps are then carried out to provide a heating element having the desired properties.

The invention has been described in detail with reference to particular embodiments thereof. However, it will be appreciated that those skilled in the art, upon consideration of this disclosure, may make modification and improvements within the spirit and scope of the invention.

1. A method for producing a resistive ceramic heating element, comprising:
a) bringing together a pre-formed zone of material with a zone of one or more materials having flow, and
b) hardening the material having flow to provide a heating element.

2. The method of claim 1 wherein the heating element is sintered to thereby form an integral coaxial heating element.

3. The method of claim 1 wherein a pre-formed insulator material is contacted with a conductive zone.

4. The method of claim 1 wherein a pre-formed insulator material is contacted with a conductive zone and a resistive zone.

5. The method of claim 1 wherein a preformed insulator material is inserted into a conductive zone composition.

6. The method of claim 1 wherein the heating element is removed from a mold after hardening.

7. The method of claim 1 further comprising adding to a mold a conductive composition and thereafter bringing together the pre-formed element and the conductive composition.

8. The method of claim 1 further comprising adding to a mold a resistive composition and a conductive composition distinct from the resistive composition and thereafter bringing together the pre-formed element and the conductive composition.

9. A coaxial ceramic heating element obtainable from a method of claim 1.

10. A coaxial ceramic heating element comprising:
a conductive core region mating with a hot resistive zone at a distal end of the heating element;
an outer conductive region separated from the conductive core region by an insulator region,
wherein at least about 5% of the joule heating of the heating element is generated in the central core.

11. A coaxial ceramic heating element of claim 10, wherein at least about 6% of the joule heating of the heating element is generated in the central core.

12. A coaxial ceramic heating element of claim 10, wherein at least about 8% of the joule heating of the heating element is generated in the central core.

13. A coaxial ceramic heating element of claim 10, wherein at least about 10% of the joule heating of the heating element is generated in the central core.

14. A coaxial ceramic heating element of claim 10, wherein at least about 20% of the joule heating of the heating element is generated in the central core.

15. A coaxial ceramic heating element of claim 10, wherein at least about 30% of the joule heating of the heating element is generated in the central core.

16. A coaxial ceramic heating element of claim 10, wherein at least about 40% of the joule heating of the heating element is generated in the central core.

17. A coaxial ceramic heating element of claim 10, wherein at least about 50% of the joule heating of the heating element is generated in the central core.

18. (canceled)

19. A coaxial ceramic heating element comprising:
a conductive core region mating with a hot resistive zone at a distal end of the heating element;
an outer conductive region separated from the conductive core region by an insulator region,
wherein the conductive core region mates with the hot resistive zone at a distance “a” away from the distal tip of the heating element that is at least about 10% the total length of the heating element.

20. A coaxial ceramic heating element of claim 19, wherein distance “a” is up to about 50% the total length of the heating element.

21. A coaxial ceramic heating element of claim 19, wherein distance “a” is up to about 20% the total length of the heating element.

22. A coaxial ceramic heating element comprising:
a conductive core region mating with a hot resistive zone at a distal end of the heating element;
an outer conductive region separated from the conductive core region by an insulator region,
wherein the hot resistive zone extends between the insulator region a distance “x” from the distal end of the insulator region, and wherein the hot resistive zone extends along the outer surfaces of the insulator region a distance “y” from the distal end of the insulator region, wherein distance “x” is approximately equal to distance “y”.

23. The coaxial ceramic heating element of claim 19 wherein
wherein the hot resistive zone extends a distance “d” between the insulator region from a distal-most end of the insulator region towards the proximal end of the device.

24. A heating element of claim 9 wherein the element is a vehicular glow plug or an appliance igniter.

25. (canceled)
